(19) United States
(12) Patent Application Publication
(10) Pub. No.: US 2017/0005414 A1
(43) Pub. Date: Jan. 5, 2017

(54) MOBILE DEVICE

(71) Applicant: Acer Incorporated, New Taipei City (TW)

(72) Inventor: Chung-Wen YANG, New Taipei City (TW)

(21) Appl. No.: 15/019,045

(22) Filed: Feb. 9, 2016

(30) Foreign Application Priority Data
Jul. 3, 2015 (TW) 104121616

(51) Int. Cl. H01Q 13/10; H01Q 1/24

(52) U.S. Cl. CPC H01Q 13/10; H01Q 1/241

(57) ABSTRACT

A mobile device includes a metal back cover and a feeding antenna element. The metal back cover has a slot. The slot has an open end and a closed end. The feeding antenna element is coupled to a signal source, and extends across the slot. An antenna structure is formed by the metal back cover, the slot, and the feeding antenna element.

### CROSS REFERENCE TO RELATED APPLICATIONS

This Application claims priority of Taiwan Patent Application No. 104121616 filed on Jul. 3, 2015, the entirety of which is incorporated by reference herein.

### BACKGROUND OF THE INVENTION

Field of the Invention

The disclosure generally relates to a mobile device, and more particularly, to a mobile device with an antenna structure.

Description of the Related Art

With advancements in mobile communication technology, mobile devices such as portable computers, mobile phones, multimedia players, and other hybrid functional portable electronic devices have become more common. To satisfy user demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some devices cover a small wireless communication area; these include mobile phones using Wi-Fi and Bluetooth systems and using frequency bands of 2.4 GHz, 5.2 GHz, and 5.8 GHz.

In order to improve the appearance, designers often incorporate metal elements into mobile devices. However, the newly added metal elements tend to negatively affect the antennas for wireless communication in mobile devices, thereby degrading the total communication quality of mobile devices. As a result, there is a need to propose a mobile device with a novel antenna structure, so as to overcome the problems of the prior art.

### BRIEF SUMMARY OF THE INVENTION

In a preferred embodiment, the invention is directed to a mobile device including a metal back cover and a feeding antenna element. The metal back cover has a slot. The slot has an open end and a closed end. The feeding antenna element is coupled to a signal source, and extends across the slot. An antenna structure is formed by the metal back cover, the slot, and the feeding antenna element.

In some embodiments, the slot substantially has a straight-line shape or an inverted L-shape.

In some embodiments, the feeding antenna element substantially has a rectangular shape or a straight-line shape.

In some embodiments, the feeding antenna element substantially has an inverted J-shape or a T-shape or an L-shape.

In some embodiments, the slot includes a first portion and a second portion. The first portion is adjacent to the open end. The second portion is adjacent to the closed end. The feeding antenna element extends across the second portion.

In some embodiments, the antenna structure further includes a parasitic element. The parasitic element is coupled to the metal back cover, and extends across the slot.

In some embodiments, the parasitic element substantially has a straight-line shape.

In some embodiments, the antenna structure is excited to generate a first frequency band and a second frequency band. The first frequency band is from about 2400 MHz to about 2500 MHz. The second frequency band is from about 5150 MHz to about 5850 MHz.

In some embodiments, the metal back cover and the slot are excited to generate the first frequency band, and the feeding antenna element is excited to generate the second frequency band.

In some embodiments, the antenna structure is a first antenna structure, and the mobile device further includes a second antenna structure. The second antenna structure is substantially a mirror image of the first antenna structure.

### BRIEF DESCRIPTION OF DRAWINGS

The invention can be more fully understood by reading the subsequent detailed description and examples with references made to the accompanying drawings, wherein:

FIG. 1A is a top view of a mobile device according to an embodiment of the invention;

FIG. 1B is a side view of a mobile device according to an embodiment of the invention;

FIG. 2 is a top view of a mobile device according to an embodiment of the invention;

FIG. 3 is a top view of a mobile device according to an embodiment of the invention;

FIG. 4 is a top view of a mobile device according to an embodiment of the invention;

FIG. 5 is a top view of a mobile device according to an embodiment of the invention;

FIG. 6 is a top view of a mobile device according to an embodiment of the invention; and

FIGS. 7A-7K are top views of mobile devices according to an embodiment of the invention.

### DETAILED DESCRIPTION OF THE INVENTION

In order to illustrate the foregoing and other purposes, features and advantages of the invention, the embodiments and figures of the invention will be described in detail as follows.

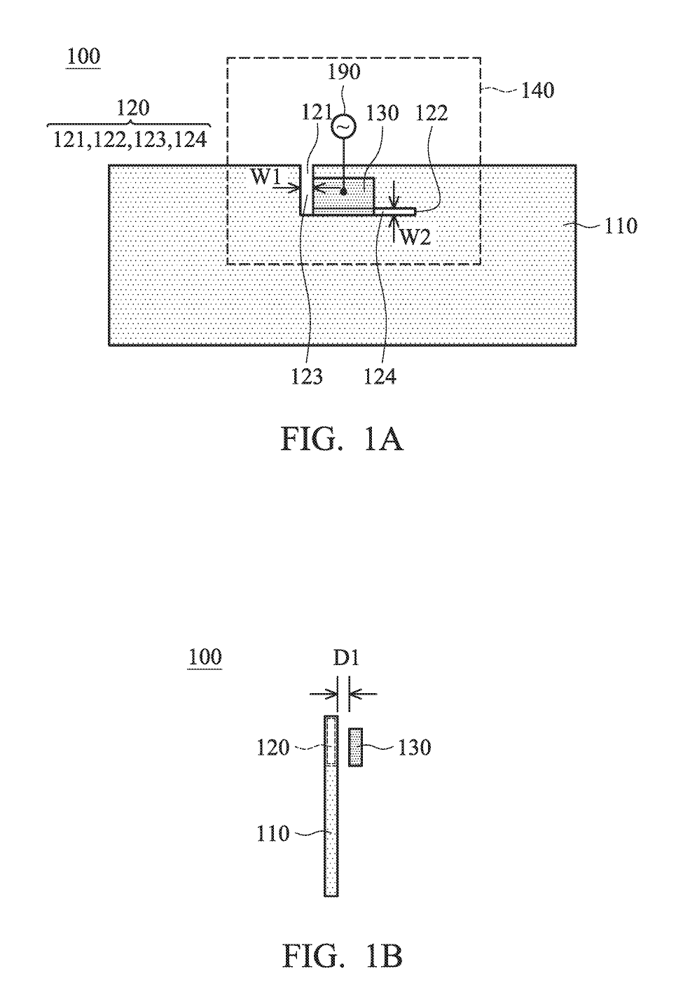

FIG. 1A is a top view of a mobile device 100 according to an embodiment of the invention. FIG. 1B is a side view of the mobile device 100 according to an embodiment of the invention. Please refer to FIG. 1A and FIG. 1B together. The mobile device 100 may be a smartphone, a tablet computer, or a notebook computer. As shown in FIG. 1A and FIG. 1B, the mobile device 100 at least includes a metal back cover 110 and a feeding antenna element 130. The metal back cover 110 may be a back cover of a mobile phone, a back cover of a tablet computer, or an upper cover of a notebook computer, and it may be used as an appearance element of the mobile device 100. The metal back cover 110 has a slot 120. The slot 120 has an open end 121 and a closed end 122, and the open end 121 is positioned at an edge of the metal back cover 110. The feeding antenna element 130 may be made of a metal material. One end of the feeding antenna element 130 is coupled to a signal source 190, and another end of the feeding antenna element 130 extends across the slot 120. In the mobile device 100, an antenna structure 140 is formed by the metal back cover 110, the slot 120, and the feeding antenna element 130. The signal source 190 may be an RF (Radio Frequency) module of the mobile device 100, and it may be configured to excite the antenna structure 140. It should be understood that the mobile device 100 may further include other components, such as a display device, a touch control module, a battery module, a speaker, and a housing (not shown).

In the embodiment of FIG. 1A and FIG. 1B, the feeding antenna element 130 substantially has a rectangular shape or a straight-line shape, and the slot 120 of the metal back cover 110 substantially has an inverted L-shape. More specifically, the slot 120 includes a first portion 123 and a second portion 124. The first portion 123 is adjacent to the open end 121, and the second portion 124 is adjacent to the closed end 122. The feeding antenna element 130 extends across the second portion 124 of the slot 120. The width W2 of the second portion 124 may be narrower than the width W1 of the first portion 123. In alternative embodiments, adjustments are made such that the width W2 of the second portion 124 may be wider than the width W1 of the first portion 123. In other embodiments, adjustments are made such that the width W2 of the second portion 124 may be equal to the width W1 of the first portion 123. Generally, if the width (W1 or W2) of the slot 120 increases, the radiation performance of the antenna structure 140 can be enhanced. As shown in FIG. 1B, the metal back cover 110 and the feeding antenna element 130 are positioned on two different parallel planes, respectively. The spacing D1 between the two planes may be from about 0.4 mm to about 3 mm. The feeding antenna element 130 may be disposed on a dielectric substrate (not shown), such as an FR4 (Flame Retardant 4) substrate or a PCB (Printed Circuit Board).

Regarding antenna theory, the antenna structure 140 can be excited to generate a first frequency band and a second frequency band. The first frequency band may be from 2400 MHz to about 2500 MHz, and the second frequency band may be from about 5150 MHz to about 5850 MHz. Specifically, the metal back cover 110 and the slot 120 form a slot antenna for covering the first frequency band, and the feeding antenna element 130 forms a monopole antenna for covering the second frequency band. In some embodiments, the feeding antenna element 130 also contributes to the relatively low first frequency band. In alternative embodiments, the feeding antenna element 130 is replaced with a PIFA (Planar Inverted F Antenna). Therefore, the antenna structure 140 can support at least the mobile communication bands of Wi-Fi and Bluetooth. In the invention, since the antenna structure 140 is integrated with the metal back cover 110, the metal back cover 110 does not affect the characteristics of the antenna structure 140. In other words, the metal back cover 110 is considered as an extension portion of the antenna structure 140, and therefore it does not negatively affect the communication quality of the mobile device 100. According to the practical measurements, the antenna efficiency of the antenna structure 140 is about 54.25% in the first frequency band and is about 51.93% in the second frequency band, and it can meet the requirement of practical application of general mobile communication devices. In comparison to the conventional designs, the invention has at least the advantages of minimizing the antenna size, reducing the manufacturing cost, and maintaining the antenna efficiency. The invention is suitable for application in a variety of small-size mobile communication devices.

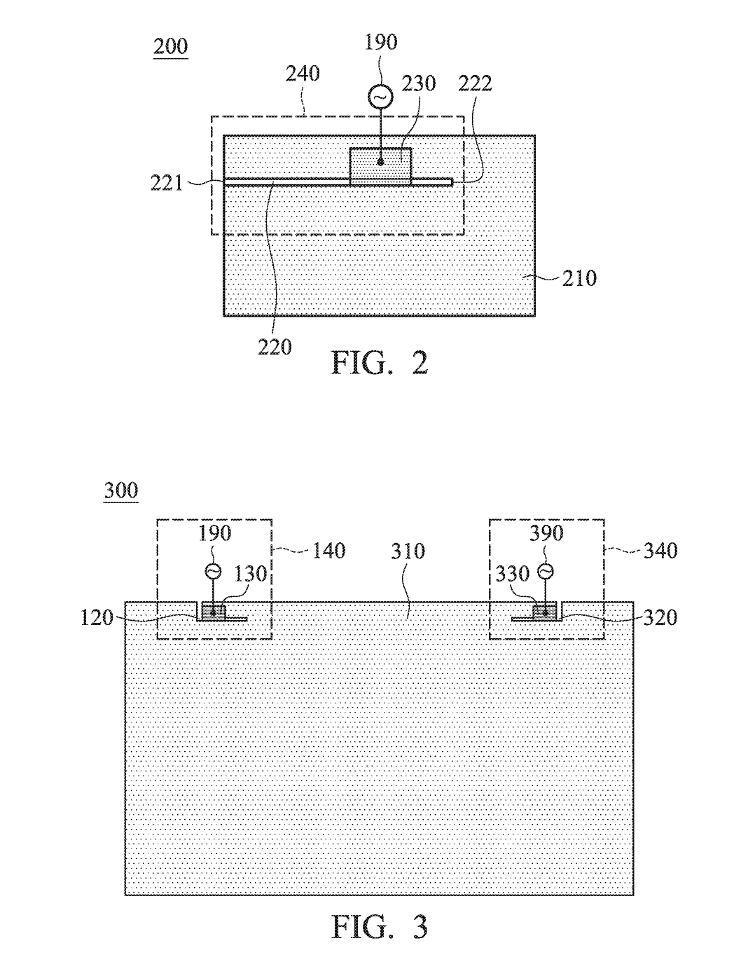

FIG. 2 is a top view of a mobile device 200 according to an embodiment of the invention. FIG. 2 is similar to FIG. 1. In the embodiment of FIG. 2, a slot 220 of a metal back cover 210 of the mobile device 200 substantially has a straight-line shape. The slot 220 has an open end 221 and a closed end 222. A feeding antenna element 230 extends across the slot 220, and the feeding antenna element 230 is closer to the closed end 222 of the slot 220. Other features of the mobile device 200 of FIG. 2 are similar to those of the mobile device 100 of FIG. 1. Accordingly, the two embodiments can achieve similar levels of performance.

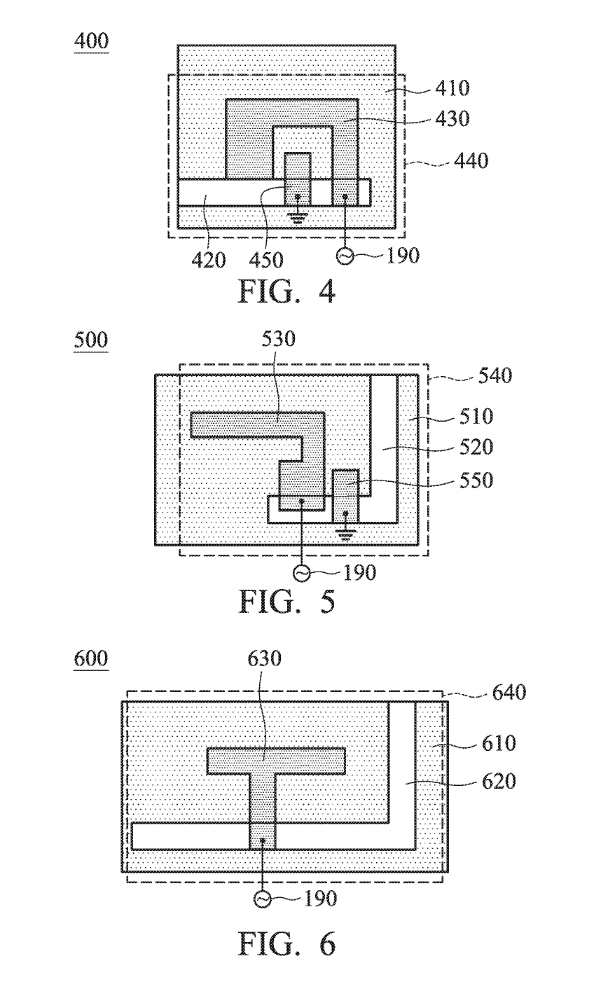

FIG. 3 is a top view of a mobile device 300 according to an embodiment of the invention. FIG. 3 is similar to FIG. 1. In the embodiment of FIG. 3, the mobile device 300 includes a first antenna structure 140 and a second antenna structure 340. The composition elements of the first antenna structure 140 have been described in the embodiment of FIG. 1. The second antenna structure 340 is substantially a mirror image of the first antenna structure 140, and the two antenna structures are symmetrical with respect to a central line of a metal back cover 310. It should be noted that a slot 320 of the second antenna structure 340 is also a mirror image of a slot 120 of the first antenna structure 140, and the two slots have an L-shape and an inverted L-shape, respectively. For example, the first antenna structure 140 may be used as a main antenna of the mobile device 300, and the second antenna structure 340 may be used as an auxiliary antenna of the mobile device 300. As a result, the mobile device 300 can support MIMO (Multi-Input and Multi-Output) functions, thereby enhancing the communication quality of the mobile device 300. In alternative embodiments, the mobile device 300 includes three or more antenna structures. Other features of the mobile device 300 of FIG. 3 are similar to those of the mobile device 100 of FIG. 1. Accordingly, the two embodiments can achieve similar levels of performance.

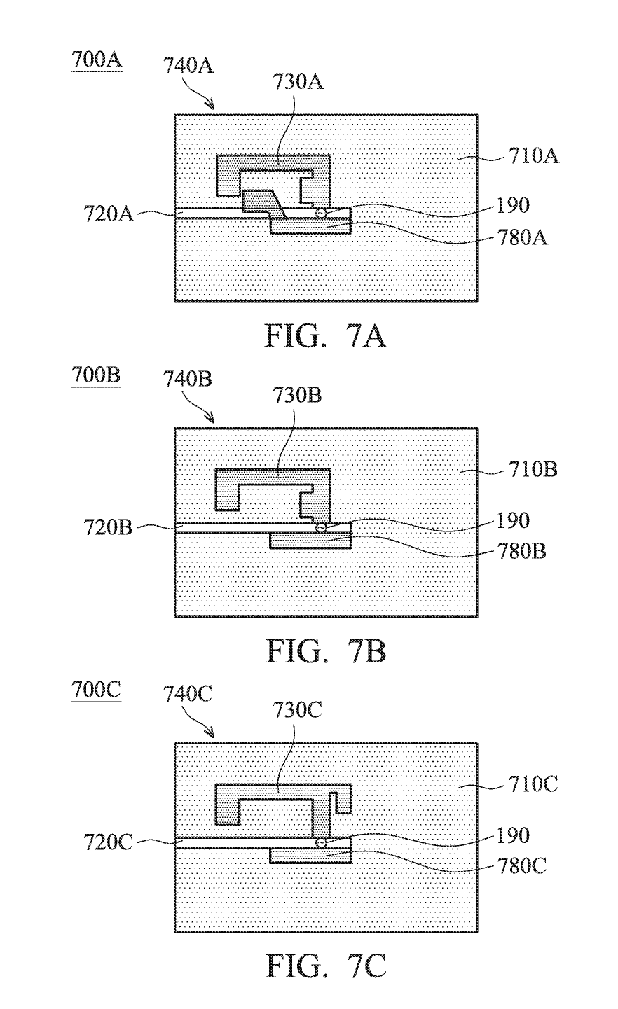

FIG. 4 is a top view of a mobile device 400 according to an embodiment of the invention. FIG. 4 is similar to FIG. 1. In the embodiment of FIG. 4, the mobile device 400 includes a metal back cover 410, a feeding antenna element 430, and a parasitic element 450. The metal back cover 410 has a slot 420, which substantially has a straight-line shape. The feeding antenna element 430 substantially has an inverted J-shape. One end (i.e., the narrower portion) of the feeding antenna element 430 is coupled to a signal source 190, and another end (i.e., the wider portion) of the feeding antenna element 430 is open. The parasitic element 450 substantially has a straight-line shape. One end of the parasitic element 450 is coupled to the metal back cover 410 (the grounding symbol in FIG. 4), and another end of the parasitic element 450 extends across the slot 420 and into a notch defined by the feeding antenna element 430. An antenna structure 440 is formed by the metal back cover 410, the slot 420, the feeding antenna element 430, and the parasitic element 450. The parasitic element 450 is excited to generate an additional 5G resonant mode, thereby widening the operation bandwidth of the antenna structure 440. Furthermore, a designer can control a coupling amount of the antenna structure 440 by adjusting the overlap between the feeding antenna element 430 and the slot 420, so as to fine-tune the impedance matching in the 2.4 GHz frequency band. Other features of the mobile device 400 of FIG. 4 are similar to those of the mobile device 100 of FIG. 1. Accordingly, the two embodiments can achieve similar levels of performance.

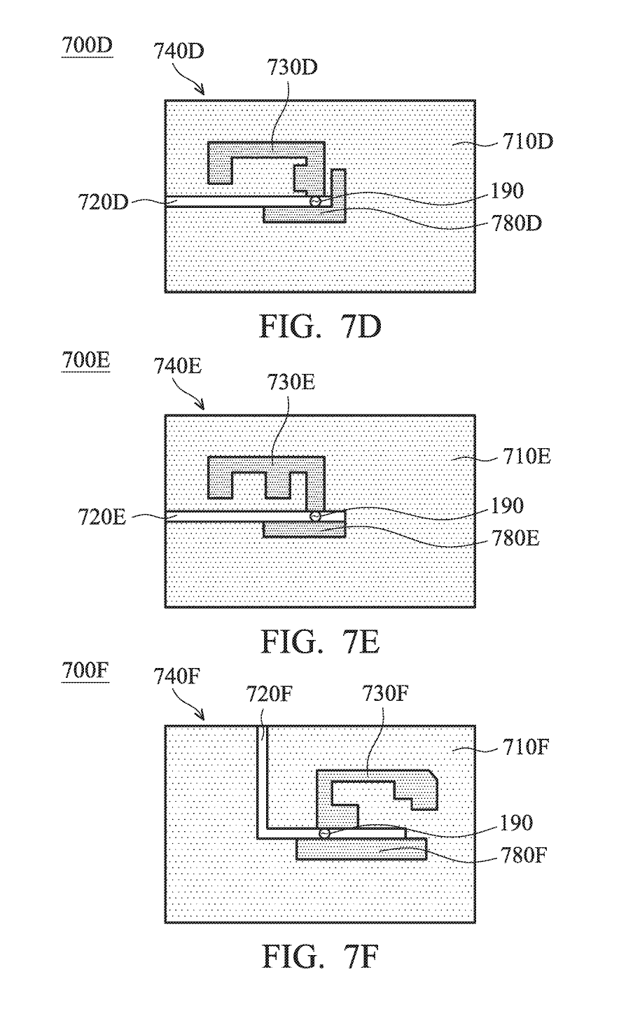

FIG. 5 is a top view of a mobile device 500 according to an embodiment of the invention. FIG. 5 is similar to FIG. 1. In the embodiment of FIG. 5, the mobile device 500 includes a metal back cover 510, a feeding antenna element 530, and a parasitic element 550. The metal back cover 510 has a slot 520, which substantially has an inverted L-shape. The feeding antenna element 530 substantially has an inverted J-shape. One end (i.e., the narrower portion) of the feeding antenna element 530 is coupled to a signal source 190, and another end (i.e., the wider portion) of the feeding antenna element 530 is open. The parasitic element 550 substantially has a straight-line shape. One end of the parasitic element 550 is coupled to the metal back cover 510 (the grounding symbol in FIG. 5), and another end of the parasitic element 550 extends across the slot 520. An antenna structure 540 is formed by the metal back cover 510, the slot 520, the feeding antenna element 530, and the parasitic element 550. Other features of the mobile device 500 of FIG. 5 are similar to those of the mobile device 100 of FIG. 1. Accordingly, the two embodiments can achieve similar levels of performance.

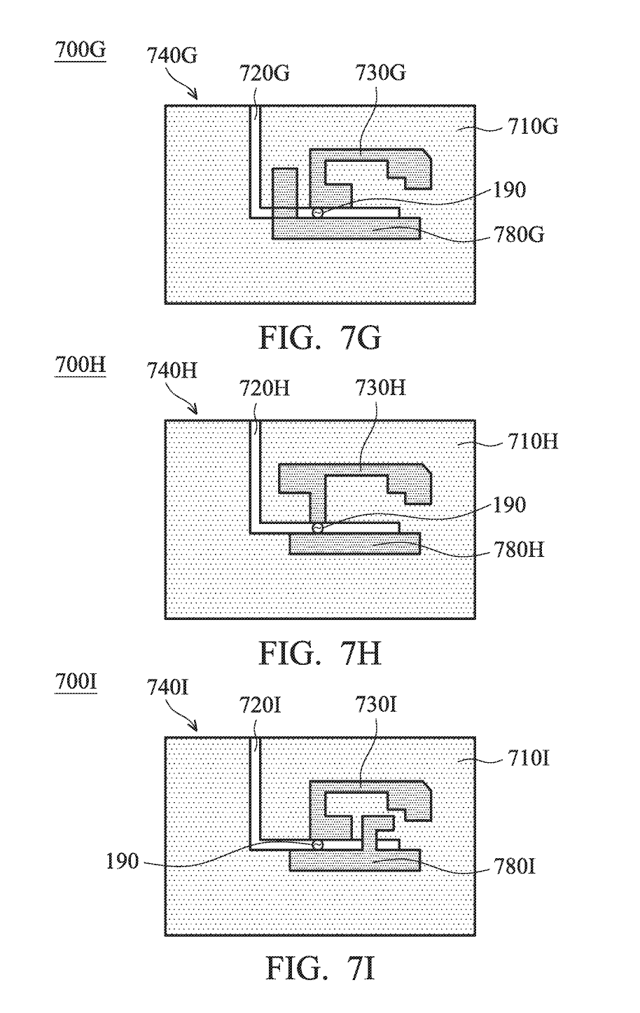

FIG. 6 is a top view of a mobile device 600 according to an embodiment of the invention. FIG. 6 is similar to FIG. 1. In the embodiment of FIG. 6, the mobile device 600 includes a metal back cover 610 and a feeding antenna element 630. The metal back cover 610 has a slot 620, which substantially has an inverted L-shape. The feeding antenna element 630 substantially has a T-shape or an L-shape. One end of the feeding antenna element 630 is coupled to a signal source 190, and the other two ends of the feeding antenna element 630 are open. An antenna structure 640 is formed by the metal back cover 610, the slot 620, and the feeding antenna element 630. Other features of the mobile device 600 of FIG. 6 are similar to those of the mobile device 100 of FIG. 1. Accordingly, the two embodiments can achieve similar levels of performance.

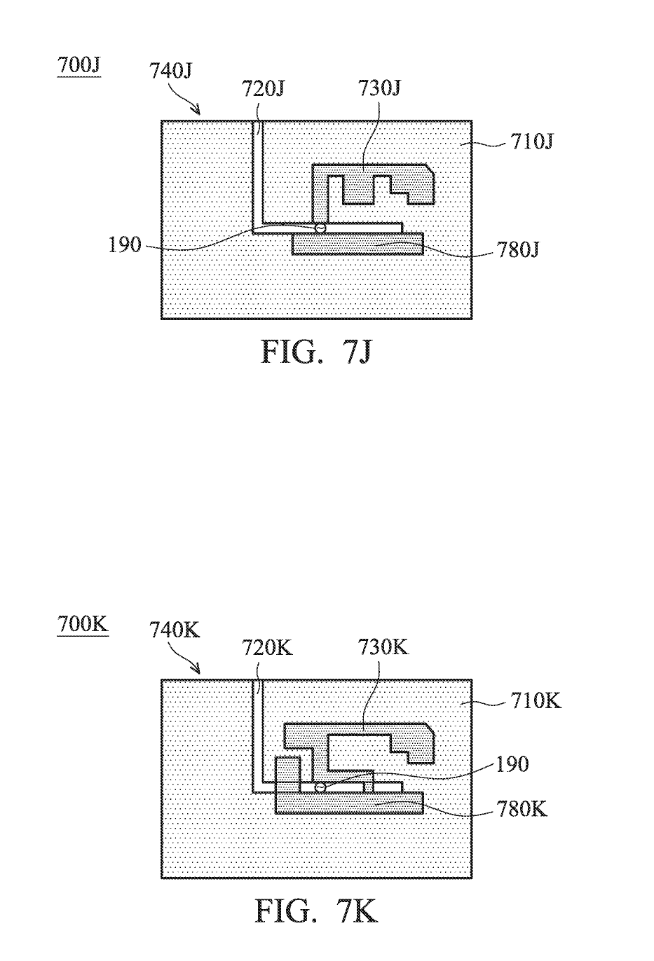

FIGS. 7A-7K are top views of mobile devices 700A-700K according to an embodiment of the invention. The mobile devices 700A-700K include metal back covers 710A-710K, slots 720A-720K, feeding antenna elements 730A-730K, and ground elements 780A-780K (providing the ground voltage) with different configurations and shapes, and such components form different antenna structures 740A-740K. Other features of the mobile devices 700A-700K of FIG. 7A-7K are similar to those of the mobile device 100 of FIG. 1. Accordingly, these embodiments can achieve similar levels of performance.

The invention provides a novel mobile device with a novel antenna structure. By combining the monopole antenna and the slot antenna with the existing metal back cover, the invention can be easily applied to a variety of mobile devices with metal back covers, and the manufacturing cost is not increased so much. According to some measurement data, if the closed end of the slot is away from the edge of the metal back cover, the radiation performance of the antenna structure will be significantly enhanced. Furthermore, if two antenna structures are designed in a single metal back cover (as shown in the embodiment of FIG. 3), the isolation (S21) between the antenna structures can be about −60 dB, which meets the requirements of general multiple antenna systems.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A mobile device, comprising:
a metal back cover, having a slot, wherein the slot has an open end and a closed end; and
a feeding antenna element, coupled to a signal source, and extending across the slot;
wherein an antenna structure is formed by the metal back cover, the slot, and the feeding antenna element.

2. The mobile device as claimed in claim 1, wherein the slot substantially has a straight-line shape or an inverted L-shape.

3. The mobile device as claimed in claim 1, wherein the feeding antenna element substantially has a rectangular shape or a straight-line shape.

4. The mobile device as claimed in claim 1, wherein the feeding antenna element substantially has an inverted J-shape or a T-shape or an L-shape.

5. The mobile device as claimed in claim 1, wherein the slot comprises a first portion and a second portion, the first portion is adjacent to the open end, the second portion is adjacent to the closed end, and the feeding antenna element extends across the second portion.

6. The mobile device as claimed in claim 1, wherein the antenna structure further comprises:
a parasitic element, coupled to the metal back cover, and extending across the slot.

7. The mobile device as claimed in claim 6, wherein the parasitic element substantially has a straight-line shape.

8. The mobile device as claimed in claim 1, wherein the antenna structure is excited to generate a first frequency band and a second frequency band, the first frequency band is from about 2400 MHz to about 2500 MHz, and the second frequency band is from about 5150 MHz to about 5850 MHz.

9. The mobile device as claimed in claim 8, wherein the metal back cover and the slot are excited to generate the first frequency band, and the feeding antenna element is excited to generate the second frequency band.

10. The mobile device as claimed in claim 1, wherein the antenna structure is a first antenna structure, and the mobile device further comprises:
a second antenna structure, wherein the second antenna structure is substantially a mirror image of the first antenna structure.
